(19) United States
(12) Patent Application Publication
(10) Pub. No.: US 2014/0316794 A1
(43) Pub. Date: Oct. 23, 2014

(54) METHOD AND SYSTEM FOR CREATING SAFETY CHECKLISTS

(71) Applicant: KONINKLIJKE PHILIPS N.V., EINDHOVEN (NL)

(72) Inventors: Roos Goll, Eindhoven (NL); Teun Van Den Heuvel, Waalre (NL)

(73) Assignee: KONINKLIJKE PHILIPS N.V., EINDHOVEN (NL)

(21) Appl. No.: 14/223,037

(22) Filed: Mar. 24, 2014

Related U.S. Application Data
(60) Provisional application No. 61/804,296, filed on Mar. 22, 2013.

(51) Int. Cl. G06F 19/00

(52) U.S. Cl. CPC G06F 19/327
USPC 705/2

(57) ABSTRACT

When optimizing a medical workflow to balance throughput and safety, a customizable checklist is generated by identifying tasks adherent to the selected workflow, and populating a checklist template with tasks as a function of a user tendency to forget the task and a severity of potential harm to a patient if the task is omitted. Reminders are added to the checklist for tasks that can harm the patient if omitted, and evaluation prompts are added for tasks that will not harm the patient if omitted and therefor can be verified by the user after performance as opposed to before performance. Pause points are inserted into the populated checklist, at which points the user is presented with the reminders and evaluation tasks, and in a manner that does not disrupt the workflow so that throughput is maximized while safety is improved.

The present innovation finds particular application in medical checklist generation systems. However, it will be appreciated that the described techniques may also find application in other checklist generation systems, other medical scenarios, or other workflow improvement techniques.

Quality and safety are becoming more and more a priority for organizations. High-reliability organizations, such as aviation, navy, nuclear power and product manufacturing, are constantly improving their safety and set an example for high risk organizations. A distinction can be made between errors of commission and errors of omission. The latter are the most dangerous, because their effects are not directly visible but can have major consequences. Systematic errors can be reprogrammed, but human errors require behavioral adjustments or adjustments to the current workflow.

A checklist can be a very powerful tool to support safety by aiding the human decision making process. In aviation pilots have extensive checklist experience and the usage of checklist is embedded in the pilot's routine. In other domains, such as healthcare, checklists are implemented; however, conventional approaches attempt to provide additional safety at the cost of productivity.

Currently there exists no methodology for developing optimal safety checklists while maintaining or improving productivity and workflow throughput. Conventional checklists are created by trial and error, which results in checklists that are not effective in improving safety while maintaining or improving throughput. Possible risks associated with using these checklists include “checklist fatigue” and disruption of the user's judgment process, which can lead to injury, unsafe situations, frustration, decreased motivation and even refusal of checklist usage, interrupted workflow, and as well as increased resource and time consumption.

The present application relates to new and improved systems and methods that facilitate generating customized workflow checklists as a function of user provided rating information, which overcome the above-referenced problems and others.

In accordance with one aspect, a system that facilitates generating checklists for medical workflows comprises a computer-readable medium that stores a plurality of medical workflows and adherent tasks, and one or more workflow checklist templates, a user interface, and a processor configured to receive input related to a selected medical workflow, receive occurrence rating input related to a likelihood of an occurrence of user omission of each task in the workflow, and receive severity rating input related to a severity of potential harm to a patient due to omission of each task from the workflow. The processor is further configured to populate a workflow checklist template with tasks adherent to the selected medical workflow as a function of the occurrence rating and the severity rating for each task, insert at least one pause point into the checklist, wherein the user is prompted to interface with the checklist during execution of the workflow at the at least one inserted pause point, and output via the user interface a populated checklist with the at least one inserted pause point.

According to another aspect, a method of generating checklists for medical workflows comprises receiving input related to a selected medical workflow, receiving occurrence rating input related to a likelihood of an occurrence of user omission of each task in the workflow, and receiving severity rating input related to a severity of potential harm to a patient due to omission of each task from the workflow. The method further comprises populating a workflow checklist template with tasks adherent to the selected medical workflow as a function of the occurrence rating and the severity rating for each task, and inserting at least one pause point into the checklist, wherein the user is prompted to interface with the checklist during execution of the workflow at the at least one inserted pause point. The populated checklist is output on a user interface with the at least one inserted pause point.

One advantage is that safety is improved.

Another advantage is that worker efficiency is improved.

Still further advantages of the subject innovation will be appreciated by those of ordinary skill in the art upon reading and understanding the following detailed description.

The innovation may take form in various components and arrangements of components, and in various steps and arrangements of steps. The drawings are only for purposes of illustrating various aspects and are not to be construed as limiting the invention.

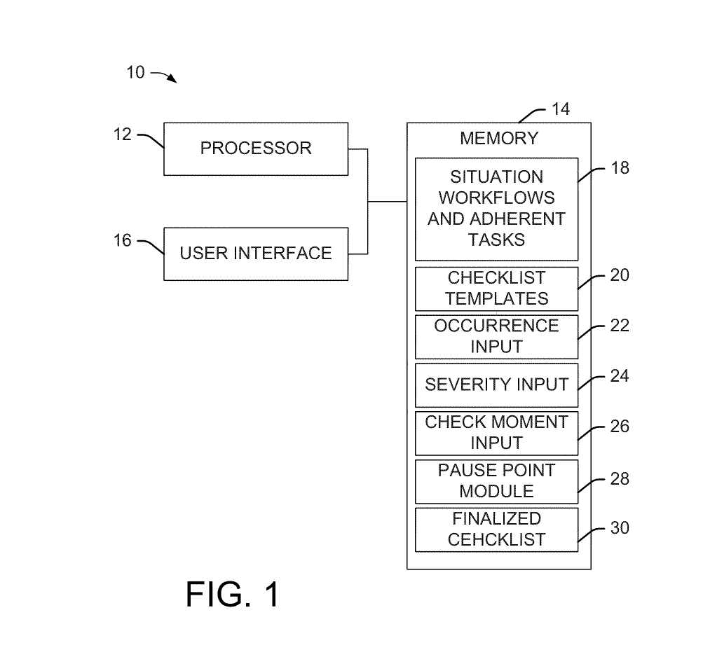

FIG. 1 illustrates a system that facilitates generating customized checklists to improve safety in a medical environment without compromising workflow throughput, wherein the checklists include tasks that are associated with “pause points” at which a user is prompted to evaluate the checklist during execution of the tasks enumerated in the checklist.

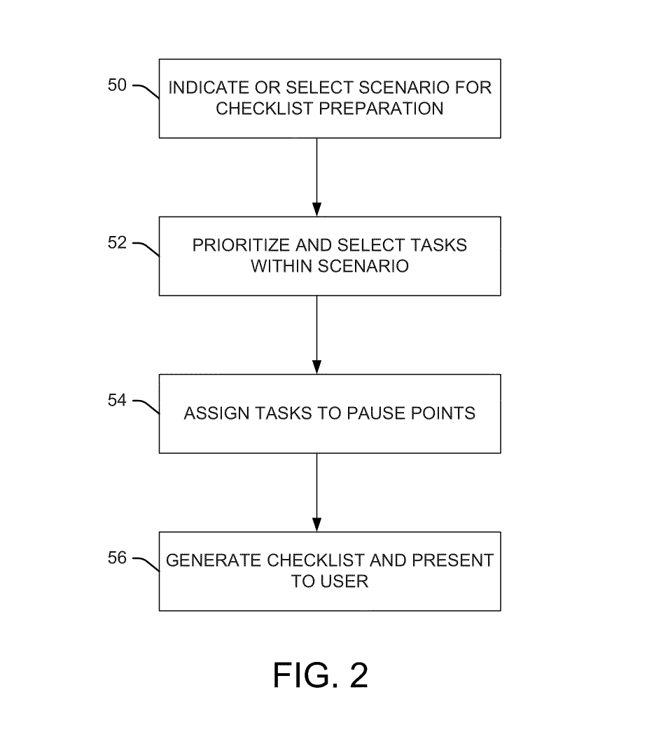

FIG. 2 illustrates a method for generating safety checklists by assigning selected tasks to pause points within the checklists.

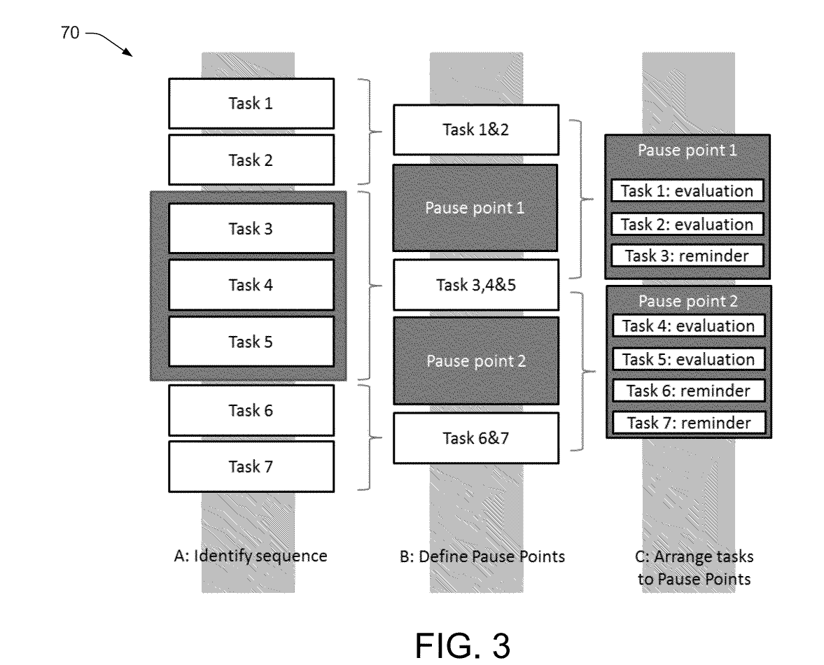

FIG. 3 illustrates a framework for assigning tasks to pause points.

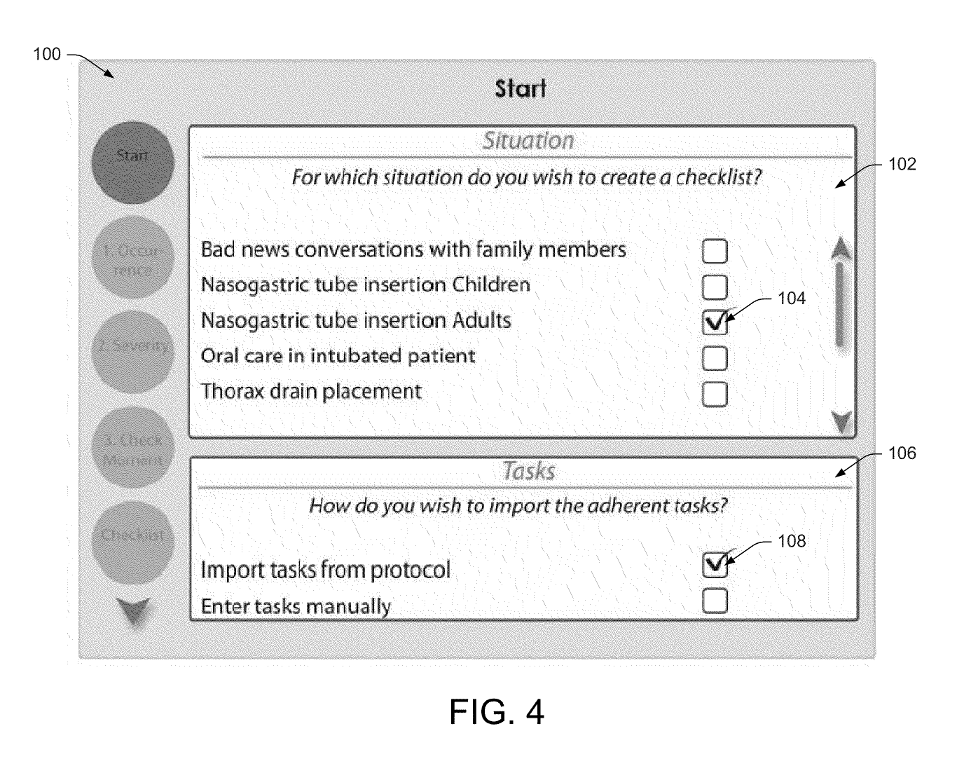

FIG. 4 shows a screenshot of a “start” screen such as may be displayed on the user interface.

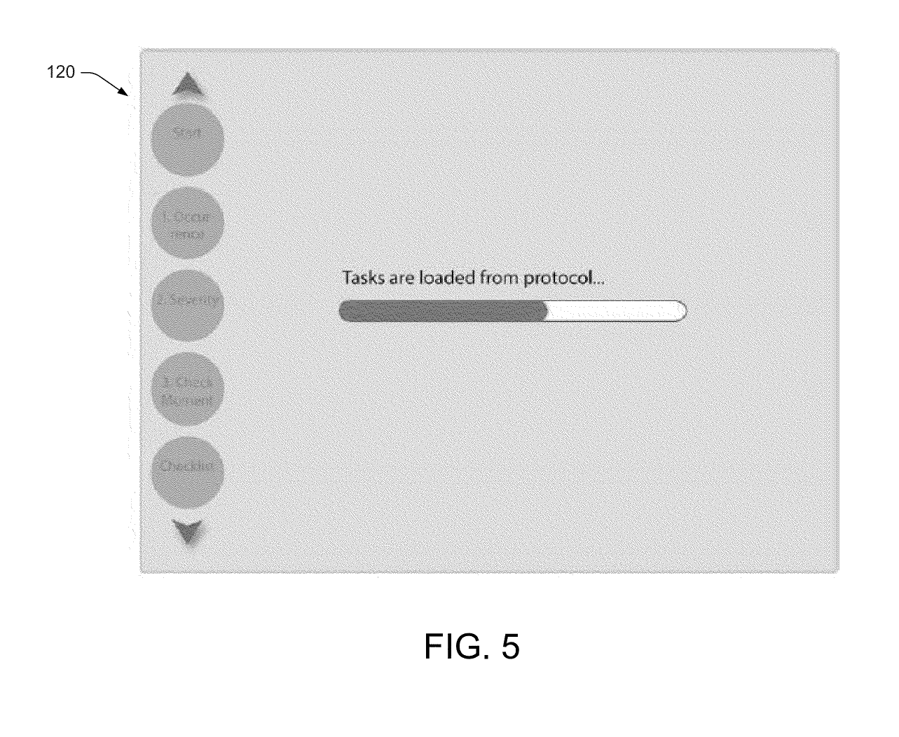

FIG. 5 shows a screenshot of a task loading screen can be presented to the user while tasks adherent to the selected situation are loaded from the memory or database.

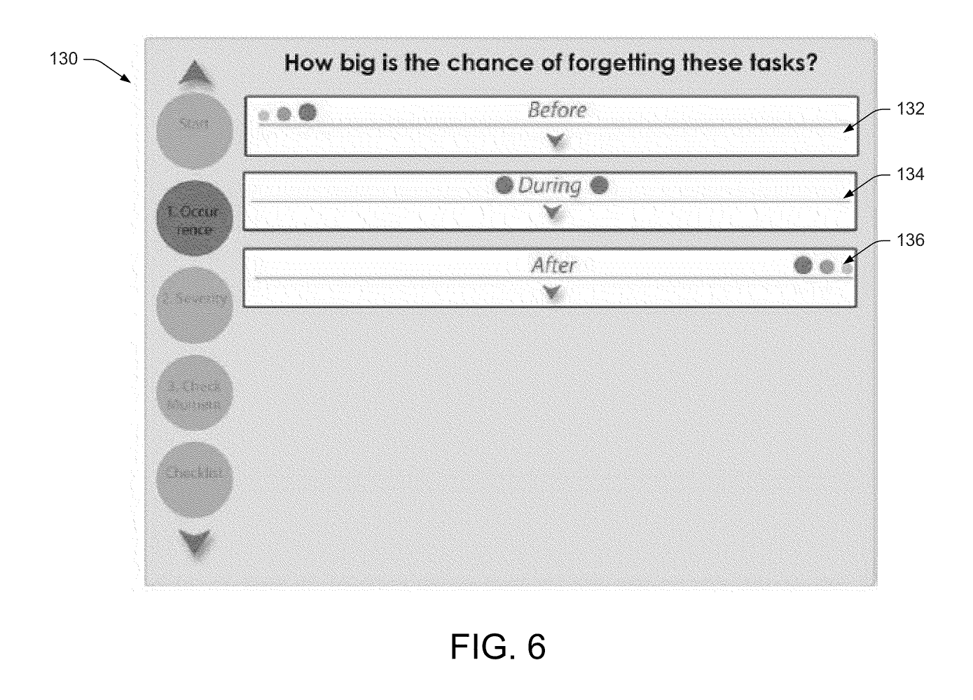

FIG. 6 shows a screenshot of an “occurrence” screen, which requests user input regarding the likelihood of a task being forgotten.

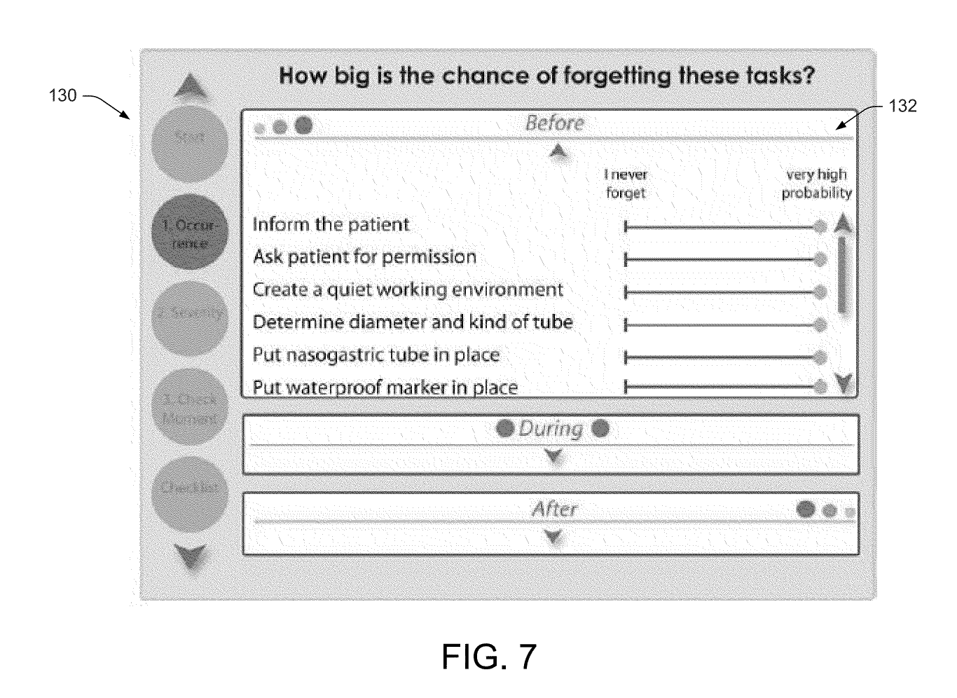

FIG. 7 shows the occurrence screen with the “before” field selected and opened.

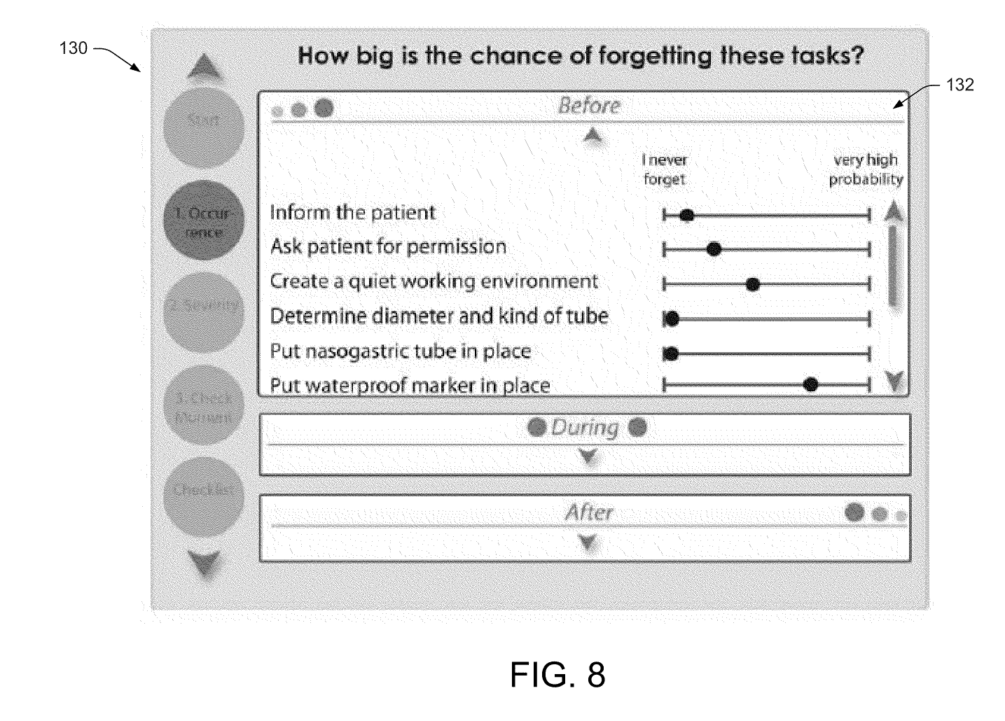

FIG. 8 shows the occurrence screen wherein in the “before” field the user has rated likelihood of a plurality of tasks being forgotten.

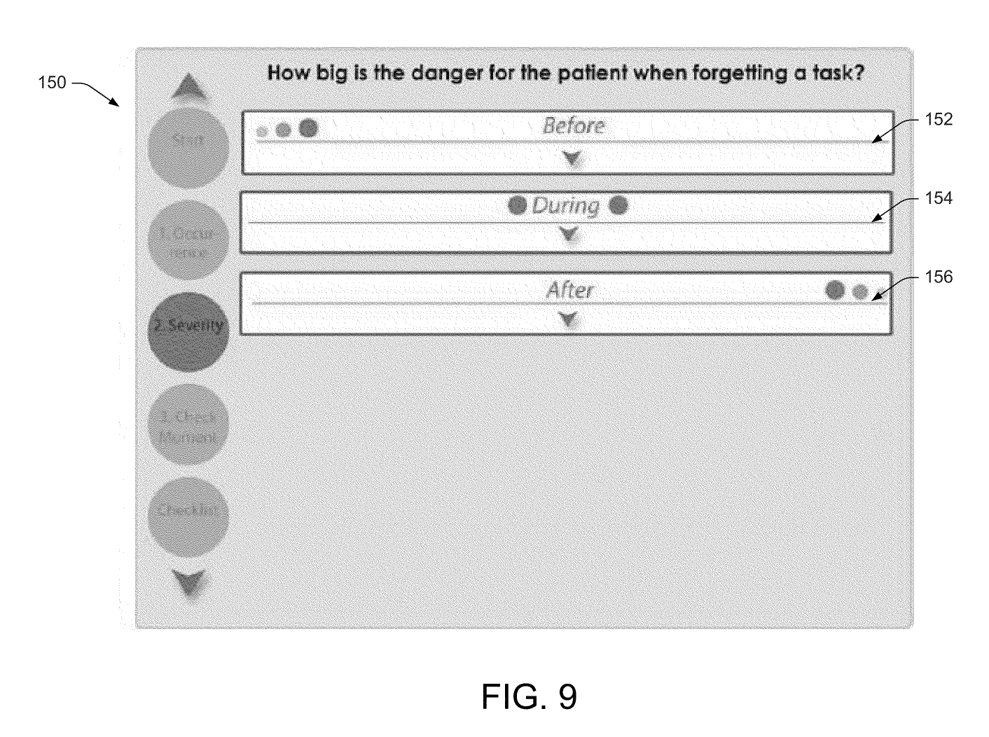

FIG. 9 shows a screenshot of a “severity” screen with selectable drop-down menus by which a user can indicate the magnitude of the danger to the patient if a particular task is forgotten before, during, and/or after (respectively) the workflow is completed.

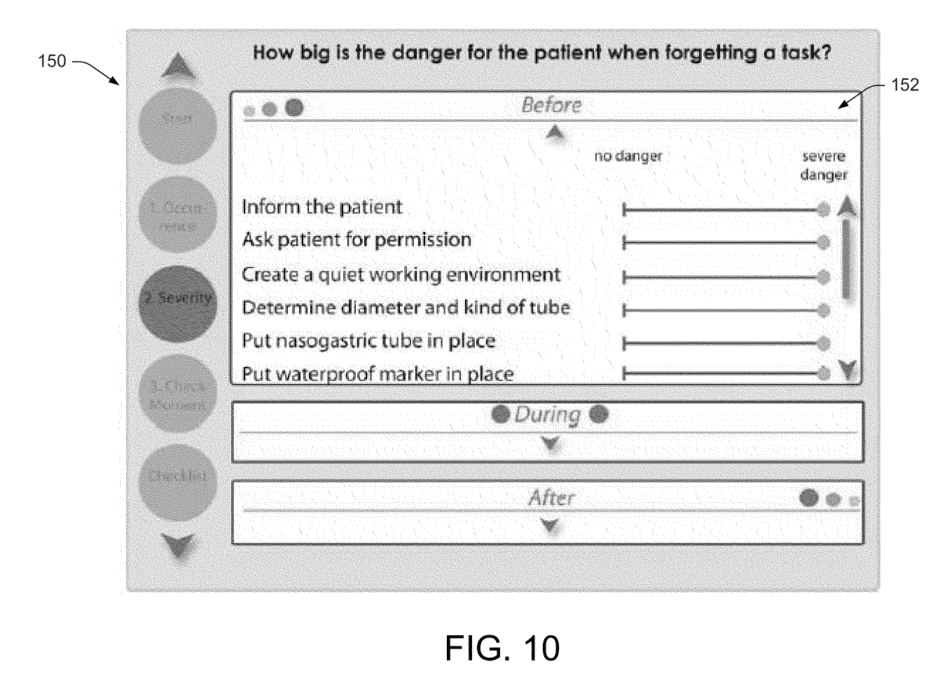

FIG. 10 shows a screenshot of the severity screen wherein the “before” field has been selected and opened by the user and includes a plurality of selectable tasks that the user can rate is posing anywhere from “no danger” up to “severe danger”.

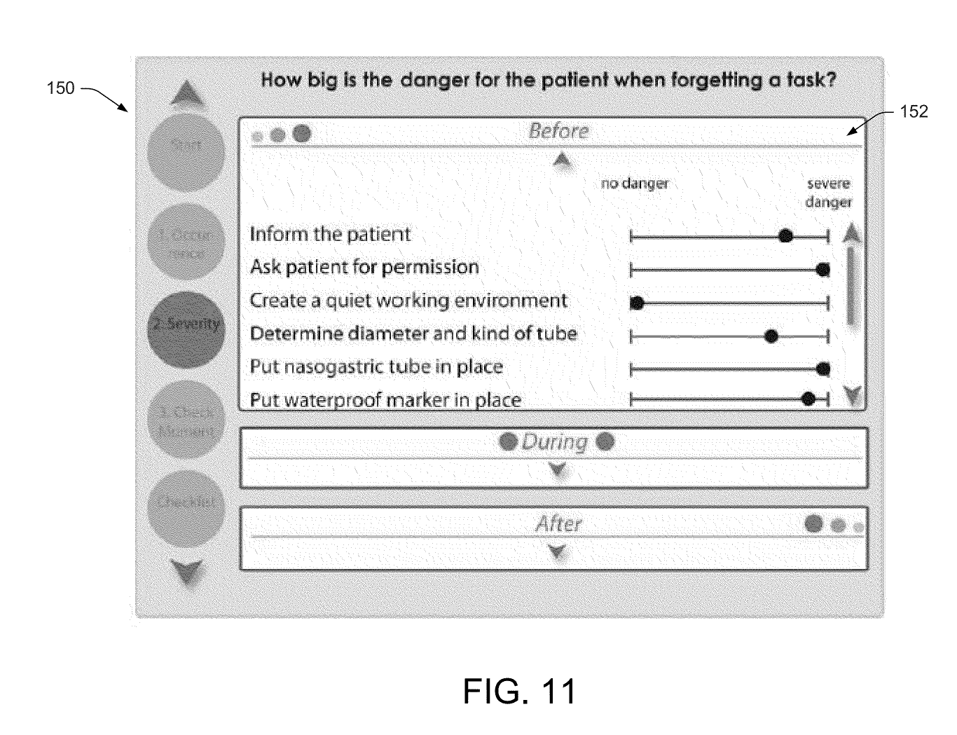

FIG. 11 shows a screenshot of the severity screen with the “before” field open, wherein the user has indicated the severity of danger to the patient should each of the enumerated tasks be forgotten.

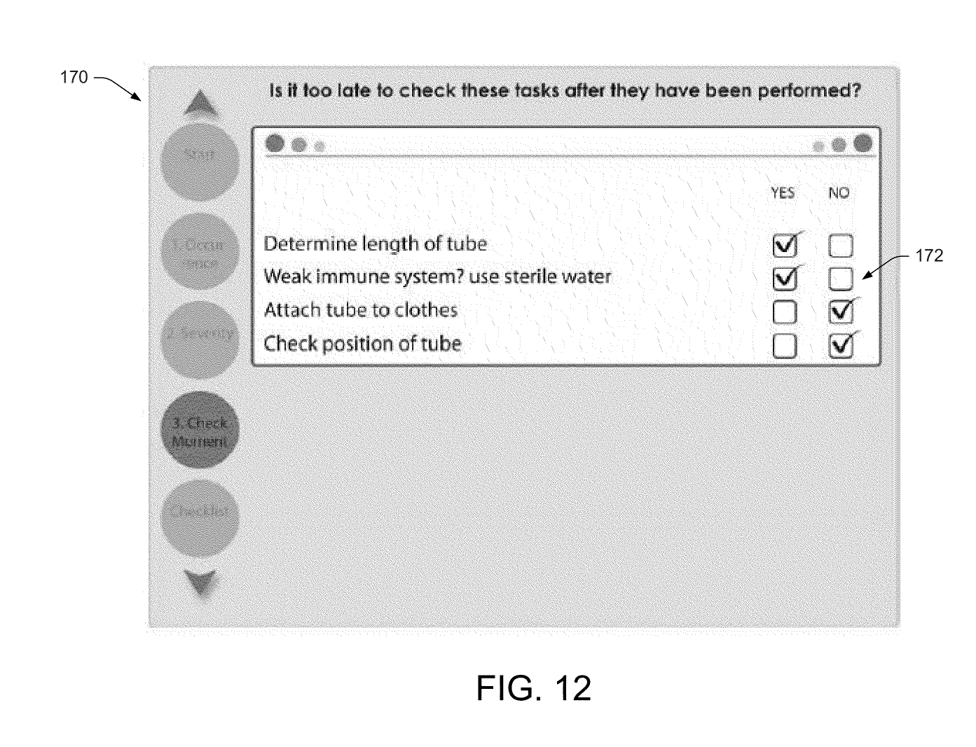

FIG. 12 shows a screenshot of a “check moment” screen wherein the user is prompted to generate “check moments” for the checklist by indicating via a plurality of checkboxes under each of a plurality of tasks needs to be checked before performance.

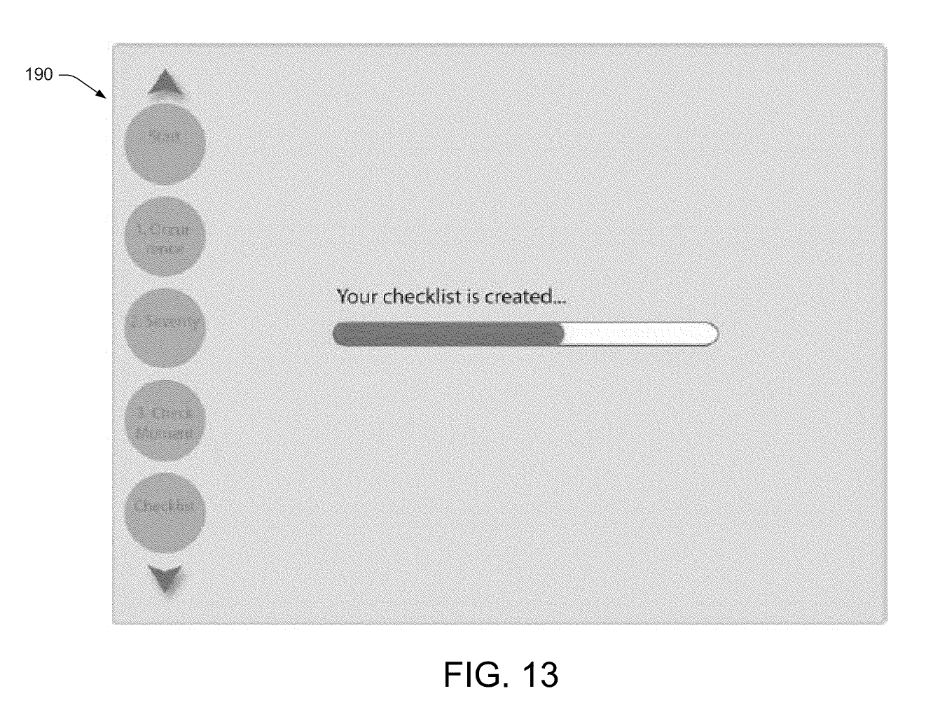

FIG. 13 shows a screenshot of a checklist creation page that can be presented to the user once the checklist is being generated.

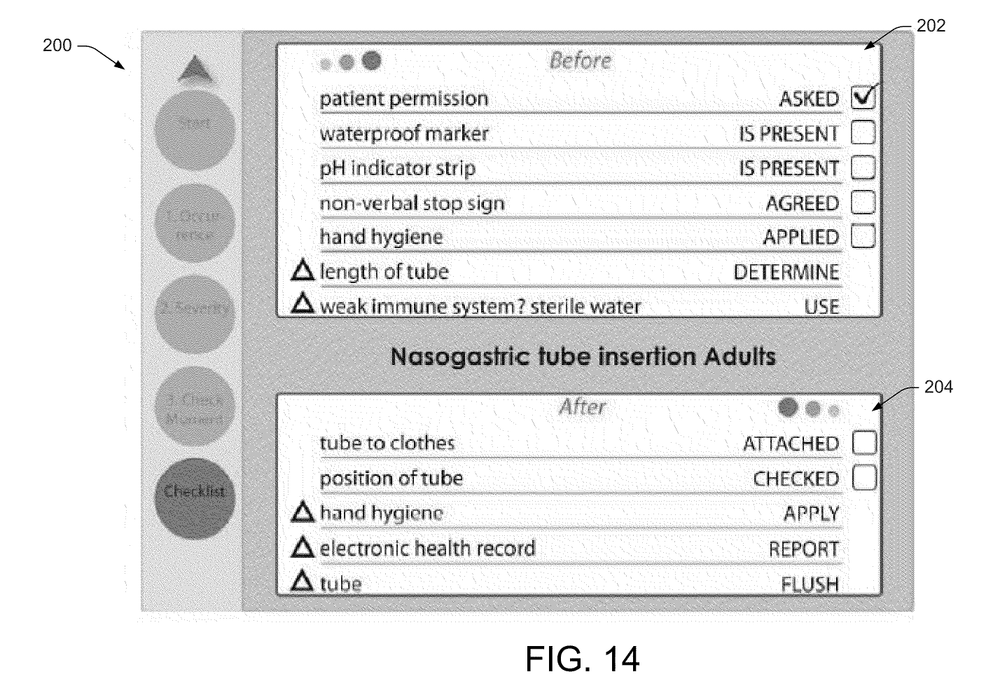

FIG. 14 shows a screenshot of the checklist, which includes a “before” field that lists tasks to be evaluated or reminded before the nasogastric tube insertion procedure and an “after” field that lists tasks to be evaluated or reminded after the nasogastric tube insertion procedure.

The subject innovation overcomes the aforementioned problems by offering a system that assists a user in finding an optimal balance between safety and productivity when creating a safety checklist that reduces error by omission. More specifically, the system provides a framework for the user to select situation workflows and adherent tasks for which a checklist is to be created, a reliable and easy to use method and framework for the user to prioritize and select the tasks, a framework for the user to determine when the items should be brought under attention without disrupting the workflow, and a clear and intuitive appearance for the user for the eventual utilization of the checklists. Generation of the optimized checklist comprises preparation and selection of a workflow, prioritizing and selection of tasks adherent to the workflow, assigning of tasks to pause points, and presentation of the checklist. The innovation can be used in contexts of safety-critical operations e.g. aviation, medicine, manufacturing, military, nuclear power, etc. The innovation can be implemented, e.g., as software on a PC, network service, mobile device, etc.

FIG. 1 illustrates a system 10 that facilitates generating customized checklists to improve safety in a medical environment without compromising workflow throughput, wherein the checklists include tasks that are associated with “pause points” at which a user is prompted to evaluate the checklist during execution of the tasks enumerated in the checklist. The system includes a processor 12 operably coupled to a memory 14 and a user interface 16. The processor 12 executes, and the memory 14 stores, computer-executable instructions (e.g., routines, programs, algorithms, software code, etc.) for performing the various functions, methods, procedures, etc., described herein. Additionally, “module,” as used herein, denotes a set of computer-executable instructions, software code, program, routine, or other computer-executable means for performing the described function, or the like, as will be understood by those of skill in the art.

The memory may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

One or more situation workflows and adherent tasks 18 are stored in memory 14. A “situation” as used herein denotes a workflow that includes a plurality of tasks and/or procedures to be performed. “Procedure” as used herein denotes a task or tasks that are to be performed sequentially and/or without interruption (e.g., without prompting the user to interface with the checklist during performance of the task(s)). In one embodiment, pause points may be inserted into the checklist at either end of a procedure but not in the middle thereof.

A user selects a situation workflow 18 (e.g. “thorax drain placement”, “intubate patient”, etc.) via the user interface 16, and selects how to import the tasks adherent to the selected workflow (e.g. import tasks from a protocol or database, enter tasks manually, etc.). The selected workflow and/or adherent tasks 18 are then loaded into a checklist template 20 that is also stored in the memory 14. The user is then prompted to provide “occurrence” rating input or information 22 via the user interface 16. The occurrence information includes the likelihood or probability that one or more tasks in the workflow could be forgotten or omitted by the user before, during, and/or after execution of the workflow. Additionally, the user is prompted to provide “severity” rating input or information 24, which includes input related to the magnitude of risk or danger posed to the patient should one or more of the tasks be forgotten or omitted before, during, and/or after execution of the workflow.

The user is then prompted to provide “check moment” input 26 indicating whether a given task may be checked or evaluated after performance (evaluation tasks) because omission of the task does not pose immediate danger to the patient, or whether the task requires a reminder prior to performance (reminder tasks) because omission of the task poses immediate danger to the patient. The processor executes a pause point module 28 that inserts pause points into the populated checklist template as a function of the check moment information provided by the user wherein the tasks adherent to the workflow are associated to pause points in a manner that ensures that the user will not be interrupted during a procedure, will be reminded ahead of time to perform tasks that may pose a risk of immediate danger to the patient if omitted, and will be prompted to evaluate or check off upon completion tasks that do not pose a risk of immediate danger to the patient if omitted. A finalized checklist 30 is then presented to the user via the user interface for use during execution of the workflow. The finalized checklist includes the tasks adherent to the selected situation workflow as well as pause points inserted into the checklist at appropriate points to prompt the user to interface with the checklist without interrupting the user unnecessarily.

With continued reference to FIG. 1, FIG. 2 illustrates a method for generating safety checklists by assigning selected tasks to pause points within the checklists. The method can be executed on the processor 12 (FIG. 1), in conjunction with the memory 14 (FIG. 1) and user interface 16 (FIG. 1). The memory stores a list of candidate checklist items and/or tasks for various activities, and furthermore serves as storage for intermediate and final results of the method. The user interface can serve as a means for inputting scores and other information by a user and for outputting results to a user.

At 50, a user indicates or selects a situation workflow and adherent tasks for which he/she would like to create a checklist. The workflows and tasks can be predefined by the system (e.g. based on protocols and guidelines, etc.), predefined by a separate expert group (e.g. based on focus groups, discussions and observations, etc.), and/or manually entered by the user (e.g. based on the user's knowledge/experience/opinion/observations). For each task, an indication is provided regarding whether the task is to be performed before, during, or after the actual procedure and/or before or after certain pause points. The predefined information is stored in the memory. The user can load data from the memory, make adjustments, and/or save changes or add new input.

At 52, tasks within the selected situation workflow are selected and prioritized. For instance, user input can be provided to rate the tasks. Based on this input the processor ranks and prioritizes the tasks. Predefined and/or user defined thresholds and/or conditions can be used to determine which tasks are important enough to appear on the final checklist. For each task, two aspects may be rated by the user. Firstly, “occurrence” is rated, which represents the likelihood of the user forgetting to perform a task in the workflow. Secondly, “severity” is rated, which represents the risk or potential danger that arises when an item is forgotten. The occurrence and severity ratings can be descriptive or numerical, qualitative or quantitative, and/or based on obtained data or user estimations. Examples of several kinds of ratings include but are not limited to: a 1 to 10 scale; daily, weekly, monthly, annually; 1/1000, 1/500, 1/200, 1/100, 1/50, 1/20, 1/10; almost certain, very high, high, moderately high, moderate, low, very low, remote, very remote, almost impossible; etc. Thresholds and optimization conditions for task selection can depend on one or both of the rated aspects. Additional conditions can be used for one task. Example criteria for including a task on the final checklist can be, without limitation: Occurrence (rate1-10)*Severity (rate1-10)≧25; Occurrence (rate1-4)+Severity (rate1-10)≧4; Severity (rate1-10)≧9; Occurrence (descriptive scale)=(daily or weekly); etc. In the present example, two aspects (severity and occurrence) are used. More aspects can be used if desired.

In one embodiment, the occurrence rating is compared to a predetermined occurrence threshold, and if above the threshold, the task is included in the checklist. Similarly, the severity rating can be compared to a predetermined severity threshold. If the severity rating is above the threshold, the task is included. Tasks with ratings below both thresholds may be omitted from the checklist.

At 54, tasks are assigned to pause points. It may not be desirable to use a checklist during an actual procedure(s), because the workflow may be interrupted. An actual procedure can be seen as a sequence of tasks that are desired to be performed in direct sequence and without interruption, and for which postponing any of the sequential tasks has negative consequences for the workflow or process outcome, e.g. injury/damage, time delay, task repetition, additional resource usage; etc. Therefore, the system knows for each situation when the user has time to use the checklist. These moments are indicated as “pause points”. Knowledge of pause point positions in the checklist for a given protocol can be predefined or manually input. In order to determine when a pause point can be implemented, the workflow is analyzed. FIG. 3 illustrates a schematic overview of the manner in which tasks can be associated to pause points, followed by a description.

At 56, the finalized checklist is presented to a user. In the presentation of the final checklist, the system indicates the following items to the user (written or visual indication). First, a distinction is made between moments when items should be checked by or pointed out to the user, e.g. using a title “PAUSE POINT 1” vs. “PAUSE POINT 2,” or placing task in different frames or boxes on the checklist, among other possibilities. Second, a distinction is made between items that serve as a reminder and items that serve as an evaluation, e.g. by providing a (actual or look-alike) check-off provision or a reminder symbol, or by displaying, e.g., “BLOODPRESSURE . . . MEASURED” vs. “BLOODPRESSURE . . . MEASURE”, etc. Third, a clear indication is provided of the CHALLENGE(subject) and according RESPONSE(verb), e.g. RESERVOIR and FILLED (or FILL). This indication can be used for the checklist title (e.g., the workflow title), as well as for the individual tasks.

It will be appreciated that the system or part of the system can be used by a single user or multiple users. Input from multiple users can be used in order to create one checklist. This input can be combined, for instance: automatically by the system, e.g. by calculating an average of the user-provided ranks, including a task if at least one person has ranked the severity(rate1-10)≧9; via automatic visualization of the input as means for discussion, for example wherein the users ranked the task individually, the system shows the average or combined input (in a graph, box plot, list, etc.,), and the users obtain the ability to discuss and reach consensus for creating one checklist; or manually wherein the users first discuss and insert only the scores they have agreed upon into the system.

FIG. 3 illustrates a framework 70 for assigning tasks to pause points. Three steps are shown, which include (A) identifying a task sequence, (B) defining pause points, and (C) assigning tasks to pause points. When analyzing task sequences (i.e. procedures), identification of sequences of tasks that should not be interrupted is performed. These sequences can be identified by experts, focus groups, or the user by analyzing the workflow. Pause points are defined once task sequences are identified. The pause points can be positioned directly before and after the identified sequence(s) of tasks. For each task that should be performed between two pause points, the user can indicate when the task should be shown on the checklist. For example, the task can be shown before the sequence of tasks is performed. In this case the user indicates that it would be too late to check whether the task is performed as intended after performing the task, and that this task should appear as “reminder” (i.e., before it is performed in the sequence of tasks) on the checklist in order to decrease the occurrence rate of forgetting. In another example, the task is presented to the user in the checklist after the sequence of tasks is (or should have been) performed. In this case, the user indicates that safety will not be affected by checking the task in the predefined pause point after the task is performed. This task appears as “evaluation” item (i.e., an item to check or evaluate after it has been performed) on the checklist in order to improve the detection rate of omission occurrence.

In the example shown in FIG. 3, during step (A), tasks 1-7 are shown, and tasks 3, 4, and 5 are determined to be a sequence or procedure that should not be interrupted by a checklist presentation. Accordingly, during step (B), pause points 72, 74 are inserted in the workflow checklist before and after the procedure that includes tasks 3, 4, and 5. During step (C), the tasks are assigned to the respective pause points. In this example, tasks 1 and 2 do not affect safety immediately if omitted and are therefore assigned to pause point 1, which is inserted into the checklist after tasks 1 and 2 are deemed to have been performed. The user can then check them off after verifying their performance. Task 3 affects safety immediately if omitted, and so also is associated to pause point 1 as a “reminder” checkpoint, so that the user of the checklist is reminded to perform the task before it is performed. Tasks 4 and 5 do not affect safety immediately if omitted, and therefore are associated with pause point 2, as “evaluation” or “verification” checkpoints and presented after the procedure. Tasks 6 and 7, which do affect safety if omitted but which are not part of the identified task sequence (procedure), are also associated with pause point 2, which is inserted into the checklist before the expected performance of tasks 6 and 7. Accordingly, tasks 6 and 7 are represented in the checklist as “reminder” checkpoints.

FIGS. 4-14 illustrate examples of screenshots that may be presented to a user during checklist generation, in accordance with one or more features described herein. The herein-described system guides the user in this example through 4 steps (e.g., start, occurrence, severity, check moment, or the like), resulting in a generated checklist for a Nasogastric tube insertion for an adult, in order to prevent intensive care staff from forgetting tasks.

FIG. 4 shows a screenshot of a “start” screen 100 such as may be displayed on the user interface 16 (FIG. 1). The start screen includes a “situation” field 102 with a plurality of selectable situation workflows from which the user may choose in order to generate a checklist therefor. The user in this example has selected a checkbox 104 corresponding to a nasogastric tube insertion for an adult. The start screen also includes a “tasks” field 106 with selectable options and from which a user may choose to import tasks adherent to the situation selected in the situation field. In this example, the user has selected a checkbox 108 for importing tasks from a protocol.

FIG. 5 shows a screenshot of a task loading screen 120 can be presented to the user while tasks adherent to the selected situation are loaded from the memory or database 14 (FIG. 1).

FIG. 6 shows a screenshot of an “occurrence” screen 130, which requests user input regarding the likelihood of a task being forgotten. The occurrence screen includes selectable dropdown menus or fields, 132, 134, and 136 for inputting information regarding the likelihood of a task being forgotten before, during, and after (respectively) a given situation workflow is completed.

FIG. 7 shows the occurrence screen 130 with the “before” field 132 selected and opened. The “before” field comprises a plurality of selectable tasks that the user can rate as having a low-to-high probability of being forgotten or omitted. It will be appreciated that although the illustrated interface employs slider bars and probabilities, any suitable manner of indicating likelihood (e.g., a 1 to 10 scale, a 1 to 5 scale, a percentage scale or bar, etc.) may be employed as previously described herein.

FIG. 8 shows the occurrence screen 130 wherein in the “before” field 132 the user has rated likelihood of a plurality of tasks being forgotten. For example, the user has indicated that he or she never forgets to determine the diameter and kind of tube to be used, or placing the tube in the patient, but that there is a higher probability of forgetting to put a waterproof marker in place.

FIG. 9 shows a screenshot of a “severity” screen 150 with selectable drop-down menus 152, 154, and 156 by which a user can indicate the magnitude of the danger to the patient if a particular task is forgotten before, during, and/or after (respectively) the workflow is completed.

FIG. 10 shows a screenshot of the severity screen 150 wherein the “before” field 152 has been selected and opened by the user and includes a plurality of selectable tasks that the user can rate as posing anywhere from “no danger” up to “severe danger”.

FIG. 11 shows a screenshot of the severity screen 150 with the “before” field 152 open, wherein the user has indicated the severity of danger to the patient should each of the enumerated tasks be forgotten or omitted. For example, the user has indicated that forgetting to create a quiet working environment would pose no danger to the patient, whereas forgetting to perform the other tasks listed would pose substantial danger to the patient.

FIG. 12 shows a screenshot of a “check moment” screen 170 wherein the user is prompted to generate “check moments” for the checklist by indicating via a plurality of checkboxes 172 under each of a plurality of tasks needs to be checked before performance (i.e., whether it is too late to check the given task after it has been performed). In the example of FIG. 12, the user(s) indicated that the position of the tube and attachment of the tube to the patient's clothes can be checked after they have been performed, whereas determining the length of the nasogastric tube and whether the patient has a weak immune system (which, if true, would prompt the use of sterile water) need to be checked prior to performance.

FIG. 13 shows a screenshot of a checklist creation page 190 that can be presented to the user once the checklist is being generated.

FIG. 14 shows a screenshot of the checklist 200, which includes a “before” field 202 that lists tasks to be evaluated or reminded before the nasogastric tube insertion procedure and an “after” field 204 that lists tasks to be evaluated or reminded after the nasogastric tube insertion procedure. Based on the user input provided via the previous screens, tasks presented in the before and after fields are marked as “evaluation” tasks and “reminder” tasks. Evaluation tasks in the illustrated example are associated with a corresponding checkbox that the user checks off upon performance, since they do not pose an immediate danger to the patient if they are verified after performance. Reminder tasks in the illustrated example are designated by a warning triangle or the like (although any suitable designation may be used), since the omission of these tasks can pose an immediate danger to the patient. That is, tasks with a check box are performed (and evaluated/checked) before the tube insertion; the “reminder” tasks are part of the actual insertion procedure, and checking these tasks for the first time after performance of the insertion procedure would be “too late”.

In one embodiment, during execution of the workflow, the user of the checklist can be required to acknowledge each reminder task (e.g. by clicking on or otherwise acknowledging the reminder task) prior to its performance and/or to verify completion of these tasks before proceeding through the checklist, in order to ensure patient safety.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

Having thus described the preferred embodiments, the invention is now claimed to be:

1. A system that facilitates generating checklists for medical workflows, including:
a computer-readable medium that stores a plurality of medical workflows and adherent tasks, and one or more workflow checklist templates;
a user interface; and
a processor configured to:
receive input related to a selected medical workflow;
receive occurrence rating input related to a likelihood of an occurrence of user omission of each task in the workflow;
receive severity rating input related to a severity of potential harm to a patient due to omission of each task from the workflow;
populate a workflow checklist template with tasks adherent to the selected medical workflow as a function of the occurrence rating and the severity rating for each task;
insert at least one pause point into the checklist, wherein the user is prompted to interface with the checklist during execution of the workflow at the at least one inserted pause point; and
output via the user interface a populated checklist with the at least one inserted pause point.

2. The system according to claim 1, wherein the processor is further configured to:
omit a task from the checklist when the occurrence rating for the task is below a predetermined occurrence threshold and the severity rating is below a predetermined severity threshold.

3. The system according to claim 1, wherein the processor is further configured to:
receive and evaluate check moment input that indicates that checking the task after performance poses an immediate danger to the patient; and
insert into the checklist template a reminder to perform the task before performance.

4. The system according to claim 1, wherein the processor is further configured to:
receive and evaluate check moment input that indicates that checking the task after performance poses no immediate danger to the patient; and
insert into the checklist template a prompt for the user to verify performance of the task after performance.

5. The system according to claim 1, wherein the processor is further configured to:
for each task, multiply the severity rating by the occurrence rating; and
include the task in the populated template when the product of the severity rating and the occurrence rating is above a predetermined value.

6. The system according to claim 5, wherein the predetermined value is a percentage of a product of a maximum severity rating and a maximum occurrence rating.

7. The system according to claim 6, wherein the percentage is not greater than 25%.

8. The system according to claim 1, wherein the processor is further configured to:
for each task, add the severity rating to the occurrence rating; and
include the task in the populated template when the sum of the severity rating and the occurrence rating is above a predetermined value.

9. The system according to claim 8, wherein the predetermined value is not greater than approximately 25% of a sum of a maximum severity rating and a maximum occurrence rating.

10. A method of generating checklists for medical workflows, including:
receiving input related to a selected medical workflow;
receiving occurrence rating input related to a likelihood of an occurrence of user omission of each task in the workflow;
receiving severity rating input related to a severity of potential harm to a patient due to omission of each task from the workflow;
populating a workflow checklist template with tasks adherent to the selected medical workflow as a function of the occurrence rating and the severity rating for each task;
inserting at least one pause point into the checklist, wherein the user is prompted to interface with the checklist during execution of the workflow at the at least one inserted pause point; and
outputting a populated checklist with the at least one inserted pause point.

11. The method according to claim 10, further comprising:
omitting a task from the checklist when the occurrence rating for the task is below a predetermined occurrence threshold and the severity rating is below a predetermined severity threshold.

12. The method according to claim 10, further comprising:
receiving and evaluating check moment input that indicates that checking the task after performance poses an immediate danger to the patient; and
inserting into the checklist template a reminder to perform the task before performance.

13. The method according to claim 10, further comprising:
receiving and evaluating check moment input that indicates that checking the task after performance poses no immediate danger to the patient; and
inserting into the checklist template a prompt for the user to verify performance of the task after performance.

14. The method according to claim 10, further comprising:
for each task, multiplying the severity rating by the occurrence rating; and
including the task in the populated template when the product of the severity rating and the occurrence rating is above a predetermined value.

15. The method according to claim 14, wherein the predetermined value is a percentage of a product of a maximum severity rating and a maximum occurrence rating.

16. The method according to claim 15, wherein the percentage is not greater than 25%.

17. The method according to claim 10, further comprising:
for each task, adding the severity rating to the occurrence rating; and
including the task in the populated template when the sum of the severity rating and the occurrence rating is above a predetermined value.

18. The method according to claim 17, wherein the predetermined value is not greater than approximately 25% of a sum of a maximum severity rating and a maximum occurrence rating.

19. A processor configured to execute computer-executable instructions for performing the method according to claim 10.
